(19) United States
(12) Patent Application Publication
(10) Pub. No.: US 2008/0067121 A1
(43) Pub. Date: Mar. 20, 2008

(54) Fluid filter element with reinforcing scrim

(75) Inventors: Dirk Dieter Hans Ter Horst, Boca Raton, FL (US); Hans Joachim Lippold, Lake Worth, FL (US)

Correspondence Address: BACHMAN & LAPOINTE, P.C., 900 CHAPEL STREET, SUITE 1201, NEW HAVEN, CT, 06510, US

(73) Assignee: LPD Technologies, Inc.

(21) Appl. No.: 11/521,679

(22) Filed: Sep. 15, 2006

(51) Int. Cl. B01D 29/07

(52) U.S. Cl. 210/493.1; 55/521; 210/483

(57) ABSTRACT

A fluid filter element includes a flat filter material folded along a series of fold lines to define a plurality of substantially adjacent walls and spaces between the walls opening in alternating opposite directions, wherein openings in one direction define an upstream side and openings in the other direction define a downstream side; and a reinforcement member attached over at least one of the upstream side and the downstream side.

### BACKGROUND OF THE INVENTION

The invention relates to a fluid filter element and, more particularly to a fluid filter element having a reinforcement to improve stability of the fluid filter element against bowing out and/or pleat structure deformation under pressure.

Fluid filter elements are well-known and are widely used in filter installations for varying areas of use, including general ventilation and fluid filtration.

The general structure for fluid filter elements in these uses can take varying shapes. One particularly desirable shape, however, is a fluid filter material formed into a zig-zag structure as generally shown in FIG. 1.

Filters such as those described above can be embossed, and two examples of particularly useful fluid filter material and elements are those disclosed in U.S. Pat. Nos. 6,685,833 and 6,997,969, related to embossed fluid filter material and elements.

Under certain circumstances, for example when a filter element has a small pleat depth or is subjected to an excessive pressure differential, the fluid filter element has a tendency to bow out. This means that the filter element moves out of position as indicated by the dashed lines of FIG. 2.

Another problem with existing filter elements is pleat structure deformation. Referring to FIG. 3, a top view of an existing filter element 1 is shown, and has a series of fold lines 2 and perpendicular glue lines 3 which extend substantially parallel over a fold lines 2. Under certain conditions, the upstream side of fluid filter element 1 can deform, specifically, the pleat walls between glue lines 2 can deform, and the spacing between adjacent glue lines 3 can decrease. FIG. 3 shows a single glue line 3a which has moved relative to adjacent glue lines 3 because of deformation of the pleat walls between glue line 3a and the adjacent glue lines. Of course, an entire filter could be affected in this manner, not just a single glue line, and the pleat wall deformation may not be as regular as that shown in FIG. 3. Nevertheless, this is a problem under certain circumstances with existing filters.

When a filter element deforms as shown in FIG. 2 or FIG. 3, the filter element fails to function as intended and can develop leakage, excessive pressure drop or rupture of the filter material.

It is the primary object of the present invention to provide a fluid filter element which is less susceptible to these issues.

It is a further object of the present invention to provide a method for making such a fluid filter element.

Other objects and advantages of the present invention will appear below.

### SUMMARY OF THE INVENTION

In accordance with the present invention, the foregoing objects and advantages have been obtained.

According to the invention, a fluid filter element is provided which comprises a flat filter material folded along a series of fold lines to define a plurality of substantially adjacent walls and spaces between the walls opening in alternating opposite directions, wherein openings in one direction define an upstream side and openings in the other direction define a downstream side; and a reinforcement member attached over at least one of the upstream side and the downstream side.

In further accordance with the invention, a method is provided for making a reinforced fluid filter element, wherein the method comprises the steps of providing a filter comprising a filter material folded along a series of fold lines to define a plurality of substantially adjacent walls and spaces between the walls opening in alternating opposite directions, wherein openings in one direction define an upstream side and openings in the other direction define a downstream side, the filter further comprising an adhesive on the fold lines; and applying a reinforcement member to the adhesive to position the reinforcement member over at least one of the upstream side and the downstream side.

### BRIEF DESCRIPTION OF THE DRAWINGS

A detailed description of preferred embodiments of the invention follows, with reference to the attached drawings, wherein:

FIG. 1 shows a fluid filter element of the type with which the subject matter of the present invention is usefully employed;

FIGS. 2 and 3 illustrate problems with existing fluid filter elements;

FIG. 4 shows a fluid filter element in accordance with the present invention;

FIG. 5 is a side view of the fluid filter element according to the invention;

FIG. 6 is an enlarged section of a preferred reinforcement member in accordance with the present invention;

FIG. 7 further illustrates an embossing of the fluid filter material of FIG. 4;

FIGS. 8-10 illustrate steps for applying a reinforcement member in accordance with the present invention.

### DETAILED DESCRIPTION

The invention relates to a fluid filter element including a reinforcement member to prevent bowing out of the fluid filter element and/or pleat deformation during use. The invention further relates to a method for preparing a reinforced fluid filter element.

FIG. 1 shows a general shape of a fluid filter element 1 which is formed from a flat filter material which is folded or otherwise formed preferably into a zig-zag shape as shown. Thus, material is folded along a series of fold lines 2, 5 and this folding defines a plurality of substantially adjacent walls 6 and spaces 7 between walls 6. The spaces 7 open in alternating opposite directions. Thus, spaces between fold lines 2 define one set of openings, while spaces between fold lines 5 define the other opposite-facing set of openings. Airflow through a fluid filter element 1 such as that shown in FIG. 1 is represented by arrow 8, and it should be readily apparent that this defines an upstream side 9 and a downstream side 10 of the fluid filter element 1.

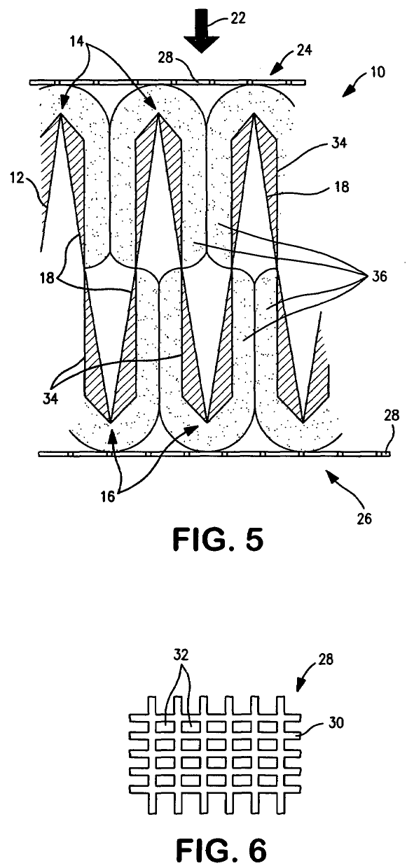

FIGS. 4 and 5 show a reinforced fluid filter element 10 in accordance with the present invention. Fluid filter element 10 is also formed from a flat filter material 12 which is folded along fold lines 14, 16 to define walls 18 between adjacent folds 14, 16. Spaces 20 are defined between walls 18 and open in alternating opposite directions. Fluid flow through this fluid filter element 10 is represented by arrow 22. Walls 18 preferably have embossings 34 which will be further discussed below.

As shown in FIGS. 4 and 5, a reinforcement member 28 is advantageously attached over fluid filter element 10. According to the invention, reinforcement member 28 can advantageously be attached over upstream side 24, or downstream side 26, or both. While FIGS. 4 and 5 show reinforcement member 28 attached over both of these sides, it should be appreciated that the present invention advantageously includes within its broad scope the use of reinforcement member 28 over either upstream side 24 or downstream side 26.

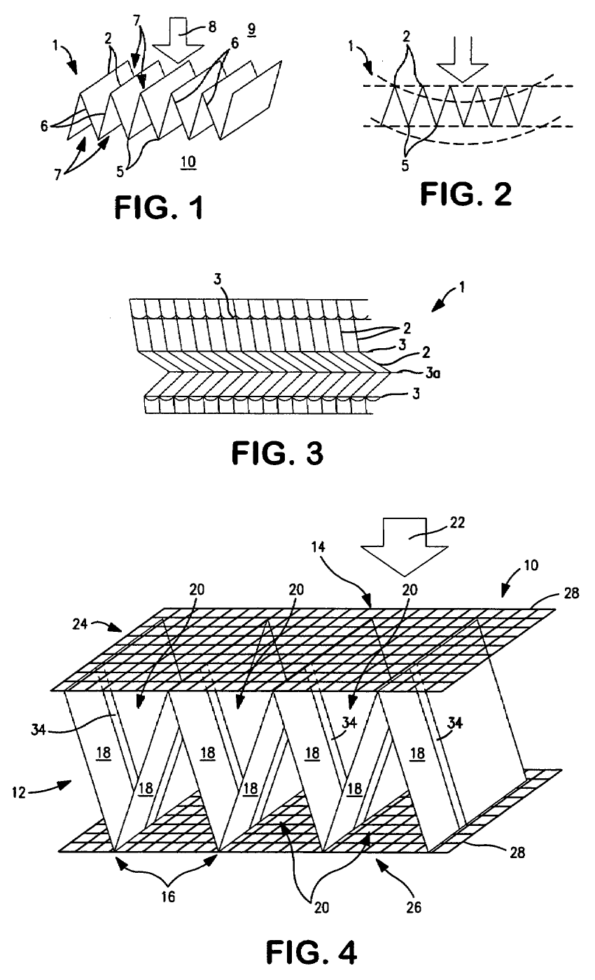

According to the invention, reinforcement member 28 is preferably a porous flat material which is selected to provide minimum resistance to air flow, while being sufficiently strong to stabilize and reinforce fluid filter element 10 against bowing out. In this regard, reinforcement member 28 can be particularly useful in either the upstream or downstream positions, for different reasons. When a filter bows out as shown in FIG. 2, spaces between fold lines at the downstream end tend to spread. In this position, reinforcement member 28 must have a very limited stretchability, or elongation under tension, so that member 28 is capable of preventing spreading of the downstream fold lines.

In an upstream position fold lines tend to contract or come together as a filter bows out, and they can also shift laterally as the pleats deform. Thus, in an upstream position, reinforcement member 28 preferably has rigidity to help resist these movements or deformations of the filter.

A preferred reinforcement member is provided of an open material, for example an open woven material, having openings or spaces formed therein having a size preferably at least 1 mm or greater.

One type of material which is particularly preferred is a scrim material, an enlarged portion of which is illustrated in FIG. 6. FIG. 6 shows a portion of scrim material 30 which is defined by woven fibers defining openings 32. Openings 32 in this figure are shown as being roughly square, it should be appreciated, however, that these openings could have any shape including a circular shape. The size of these openings, as measured by either diameter or width of a square, is preferably greater than or equal to about 1 mm. This provides a reinforcement member which has sufficient strength to reinforce fluid filter element 10 as desired, while providing a minimum resistance to airflow, also as desired.

It should be appreciated that a structure as illustrated in FIG. 6, while preferred in accordance with the present invention, is not the only structure of a reinforcement member which can advantageously reinforce fluid filter element 10 according to the invention, and that other structures can suitably be provided which have a low resistance to airflow, well within the scope of the present invention. While different conditions may at times call for or justify different values, it is preferred that the reinforcement member according to the invention present a pressure drop of less than 0.02 inches (W.G.) at an air flow velocity of between about 2.7-3.5 m/s, preferably less than about 0.01 inches (W.G.).

Reinforcement member 28 can be advantageously used for reinforcing fluid filter element 10 of any structure. However, certain sizes and shapes of fluid filter elements are particularly susceptible to bowing out during use, and are therefore advantageously combined with reinforcement member 28 in accordance with the present invention.

Embossed fluid filter elements 10, particularly fluid filter elements which have been embossed to a large depth as discussed in the aforesaid U.S. Pat. No. 6,997,969, can advantageously benefit from the reinforcement member 28 of the present invention. FIGS. 4 and 5 show a fluid filter element 10 having an embossing 34 which is schematically illustrated. It should be appreciated that embossing 34 could have a more complex structure. One example of a preferred type of embossing is that which is disclosed in the aforesaid U.S. Pat. No. 6,685,833. Further, a plurality of embossings 34 would be positioned along the material 12 defining walls 18. Thus, while a single embossing is shown in FIGS. 4 and 5, the width of material to define a complete fluid filter element 10 may have two or more substantially parallel embossings.

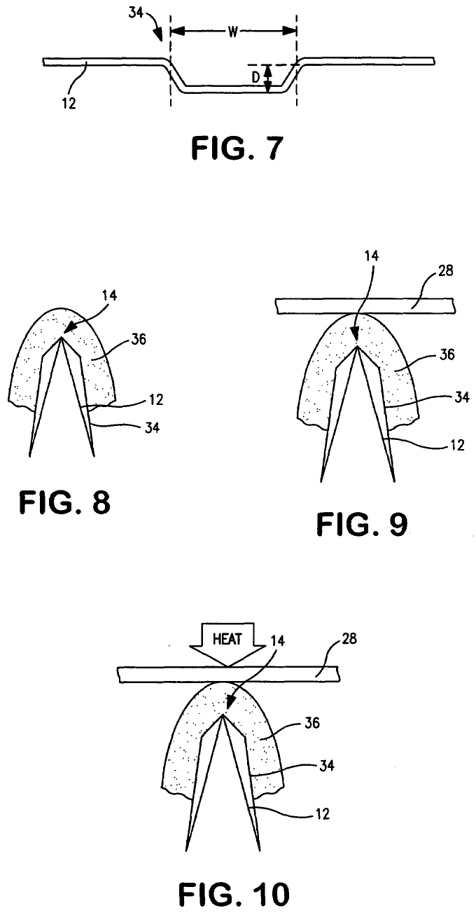

FIG. 7 shows an enlarged cross section through the filter material having an embossing 34, and shows the width and depth of embossing 34.

While the reinforcement member of the present invention is useful for all filter construction, it is particularly useful when the filter material has deep embossings.

Thus, according to the invention, reinforcement member 28 is particularly useful with fluid filter elements 10 defined by filter material 12 which has embossings to a depth D of at least about 1 mm, preferably at least about 2 mm.

In further accordance with the present invention, the reinforcement member 28 is particularly useful with fluid filter elements 10 which will be subjected to relatively large pressure drops. One type of such fluid filter element 10 is one which has been formed into a pleated structure having a pleat height, which is measured as the vertical distance between planes of the opposite folds of the structure, of less than or equal to about 12 inches (30.6 cm), preferably less than or equal to about 4 inches (10.2 cm). Some common uses of these types of fluid filter elements subject them to very high pressure drops, and reinforcement member 28 according to the invention can advantageously be employed in these circumstances as well.

A further aspect of the present invention is the method for attachment of the reinforcement member to fluid filter element 10. Structures such as those disclosed in this application are frequently connected by saturating the various element with glue or adhesive and then bonding the elements together. It should be appreciated, however, that saturating reinforcement number 28 with glue or adhesive would increase the resistance of this member to flow of air, and therefore interfere with proper operation of the reinforced fluid filter element.

According to the invention, and as illustrated in FIGS. 8-10, reinforcement member 28 can advantageously be attached to fluid filter element 10 by attaching member 28 to a glue line or adhesive 36 which is typically already in place on fluid filter element 10. FIG. 8 is a section view through the glue line and shows adhesive 36 as the partially shaded portions over fold line 14. It should be appreciated that this adhesive is preferably positioned substantially perpendicular to fold lines 14, and spaced along the width of fluid filter element 10 in accordance with the present invention.

This glue line or adhesive is typically dry by the time a reinforcement member would be applied to fluid filter element 10. According to the invention, however, this adhesive, which is preferably a hot melt adhesive, can be re-heated to soften the adhesive and restore some tackiness to same, and the reinforcement member can then be adhered to the softened adhesive already on fluid filter element 10. It is also within the broad scope of the present invention to position reinforcement member 28 over adhesive 36 is already tacky, either fresh from manufacture or due to a heating step prior to applying the reinforcement member 28.

FIG. 8 shows an enlarged portion of a fold line 14 of fluid filter element 10, including adhesive 36.

FIG. 9 shows reinforcement member 28 positioned onto adhesive 36.

FIG. 10 shows application of heat to the adhesive, through member 28, to soften the adhesive and make the adhesive tacky as discussed above. This causes reinforcement member 28 to be attached to adhesive 36 and thus fluid filter element 10 without the need for saturating the reinforcement member 28 with additional glue or adhesive.

The invention is advantageously used with any suitable filter material, adhesive and reinforcement member material. Within these broad categories, it is preferred that the reinforcement member or scrim have a higher melt point than the adhesive. With this type of material, the key is for the reinforcement member material to be able to withstand a temperature slightly exceeding the melting point temperature of the adhesive.

The adhesive can be any of a wide range of suitable glues or other material which is typically used in the construction of the fluid filter element. Preferably, the adhesive is a glue line or bead. A hot melt adhesive, for example EVA, is particularly preferred as it has a very well defined melting point. With EVA as the adhesive, a reinforcement member made from polypropylene or polyester would be particularly desirable from a melting point perspective.

While the method discussed is based upon use of a heat activated glue or adhesive, it is within the scope of the invention to use other systems, such as ultrasonic welding of member 28 directly to either the glue beads (i.e., adhesive 36), or to fold lines 14, 16 of filter member 10. A further alternative would be to apply adhesive in a glue line over reinforcement member 28 and fluid filter element 10. Each of these approaches is considered to be within the broad scope of the present invention.

It should be appreciated that the present invention has provided a reinforced fluid filter element which resolves the issues described above in connection with bowing out under pressure and pleat deformation. It should further be appreciated that a method is provided for making a fluid filter element with reinforcement according to the invention wherein the method enhances the proper functioning of the resulting reinforced fluid filter element.

It should also be appreciated that this detailed description is given in terms of preferred embodiments of the present invention, and that the details of these preferred embodiments are not to be considered as limiting upon the broad scope of coverage of the present application. Rather, this scope is defined by the claims as appended and reasonable equivalents thereto.

We claim:

1. A fluid filter element, comprising:
a flat filter material folded along a series of fold lines to define a plurality of substantially adjacent walls and spaces between the walls opening in alternating opposite directions, wherein openings in one direction define an upstream side and openings in the other direction define a downstream side; and
a reinforcement member attached over at least one of the upstream side and the downstream side.

2. The fluid filter element of claim 1, wherein the reinforcement member comprises a porous flat material.

3. The fluid filter element of claim 2, wherein the porous flat material is an open material having openings at least 1 mm in size.

4. The fluid filter element of claim 2, wherein the porous flat material is a scrim material.

5. The fluid filter element of claim 1, wherein the reinforcement member is attached over the upstream side.

6. The fluid filter element of claim 1, wherein the reinforcement member is attached over the downstream side.

7. The fluid filter element of claim 1, wherein the reinforcement member is attached over both the upstream side and the downstream side.

8. The fluid filter element of claim 1, wherein the flat filter material is embossed.

9. The fluid filter element of claim 8, wherein each wall has at least one embossing running along the wall between fold lines that define the wall.

10. The fluid filter element of claim 8, wherein the filter material is embossed to a depth of at least about 10 mm.

11. The fluid filter element of claim 1, wherein the filter material is folded to define a pleated structure having a pleat height of less than about 12 inches (30.6 cm).

12. The fluid filter element of claim 1, wherein the filter material is folded to define a pleated structure having a pleat height of less than about 4 inches (10.2 cm).

13. A method for making a reinforced fluid filter element, comprising the steps of:
providing a filter comprising a filter material folded along a series of fold lines to define a plurality of substantially adjacent walls and spaces between the walls opening in alternating opposite directions, wherein openings in one direction define an upstream side and openings in the other direction define a downstream side, the filter further comprising an adhesive on the fold lines; and
applying a reinforcement member to the adhesive to position the reinforcement member over at least one of the upstream side and the downstream side.

14. The method of claim 13, wherein the applying step comprises positioning the reinforcement member over the adhesive, and heating the adhesive sufficiently to make the adhesive tacky, whereby the reinforcement member is secured to the adhesive.

15. The method of claim 14, wherein the reinforcement member is made of a material having a melting point which is greater than a melting point of the adhesive, and wherein the heating step comprises heating the adhesive to a temperature which is less than the melting point of the reinforcement member.

16. The method of claim 14, wherein the heating step comprises heating the adhesive through the reinforcement member.
